(19) United States
(12) Patent Application Publication
(10) Pub. No.: US 2025/0383921 A1
(43) Pub. Date: Dec. 18, 2025

(54) COMPUTER-EXECUTABLE AGENT

(71) Applicant: Microsoft Technology Licensing, LLC, Redmond, WA (US)

(72) Inventors: Rogerio BONATTI, Wexford, PA (US); Mohsen FAYYAZ, Berlin (DE); Justin James WAGLE, Pacifica, CA (US)

(21) Appl. No.: 18/742,993

(22) Filed: Jun. 13, 2024

(51) Int. Cl. G06F 9/50

(52) U.S. Cl. CPC G06F 9/5027

(57) ABSTRACT

Various features pertaining to a computer-executable agent are described herein, where the computer-executable agent is configured to complete a multi-step task requested by a user. Several machine learning models, optionally distributed between a server computing system and a client computing device, are utilized to complete the task. The machine learning models generate a high-level plan that describes steps that are to be performed to complete the multi-step task, and further generate low-level plans that describe, for each step, a sequence of actions to be performed by the computer-executable agent to complete the step.

### BACKGROUND

Computer-executable agents have been incorporated into computing devices to assist users of the computing devices with completing certain tasks. For instance, a mobile telephone includes an agent (also referred to as a digital assistant) that can assist a user by providing information regarding current weather conditions, making a phone call, sending a text message, amongst other predefined tasks. The agent assists the user with such tasks based upon predefined rules and application programming interfaces (APIs) for a relatively small number of applications, where the APIs enable the agent to communicate with the applications. In an example, an API is defined for an application for “company A”, and an agent executing on a client computing device receives user input “I would like to order a pepperoni pizza from company A.” The agent communicates with the aforementioned application by way of the API to facilitate ordering a pizza by way of the application.

When, however, the user requests that the agent assist with performing a task that is not amongst a set of predefined tasks supported by the agent or for which there is no API for an application that is able to perform the task, the agent is limited to initiating a web search based upon user input and returning search results to the user. For instance, if the user input is “help me organize a cowboy-themed birthday party by finding decorations, assisting with food, and drafting an invitation card,” the agent will initiate a web search based upon such input and return to the user a ranked list of search results identified during the web search. The user must then manually perform the tasks that were requested to be performed by the agent by navigating several webpages.

Relatively recently, computer-executable agents have been designed to incorporate use of generative models, such as large language models (LLMs), to assist users with performing tasks. An agent that includes or otherwise utilizes a generative model receives user input and then provides textual responses in a chat interface to a user based upon such user input. For instance, when the digital assistant receives the input “help me organize a cowboy-themed party by finding decorations, assisting with food, and drafting an invitation card”, the agent returns a textual response in a chat interface, where the textual response is configured to assist the user with locating decorations, creating a menu, and forming an invitation. The textual response may also include links to webpages that include content or functionality that may assist the user with performing the tasks referenced above. Nevertheless, the user must manually perform the tasks, as the agent is limited to providing the textual response referenced above.

### SUMMARY

The following is a brief summary of subject matter that is described in greater detail herein. This summary is not intended to be limiting as to the scope of the claims.

Described herein are various technologies pertaining to a computer-executable agent that is able to interact with computer-executable applications to complete tasks requested by a user; the computer-executable agent described herein is in contrast to existing agents, which are limited to initiating web searches, returning textual responses in a chat interface, or performing one of a relatively small number of predefined tasks. In an example, upon receipt of the user input “help me organize a cowboy-themed birthday party by finding decorations, assisting with food, and drafting in invitation card,” the agent described herein can cause a web browser to load a webpage that can be interacted with to acquire decorations, identify decorations on the webpage for a cowboy-themed party, and add the decorations to an electronic shopping cart of the webpage. Further, the agent can construct a menu that includes several food items that are suitable for a birthday party, cause a web browser to load a webpage of a grocery store, locate the food items, and add the food items to an electronic shopping cart of the grocery web page. Still further, the agent can launch a computer-executable application (installed on the computing device of the user) that is designed to create cards, construct an example invitation, and present such invitation to the user. Hence, the agent performs the tasks requested by the user.

In an example, the agent uses several machine learning models in connection with interpreting input set forth by users and performing tasks requested in the input set forth by the users. In an example, upon receipt of input, a prompt is constructed and provided to a generative model (e.g., an LLM), where the prompt requests that the generative model generate a high-level plan for completing task(s) requested in the input. The input can be user input or input generated by a machine learning model (or other computer-executable module). For instance, the generative model outputs an acyclic graph that includes nodes and edges, where the nodes are representative of steps to be performed in connection with completing the task(s) and the edges represent relationships between the steps. Subsequent to the generative model outputting the acyclic graph, content of a node (e.g., a step) can be provided to a second generative model that is trained to output a low-level plan for the step, where the low-level plan is a sequence of actions that can be performed to complete the step. Hence, each step can be further broken down into a sequence of actions. In an example, the generative model that generates the high-level plan executes on a server computing system while generative model(s) that generates the low-level plans execute on a client computing device operated by the user.

Numerous other machine learning models are employed in connection with generating the high-level plan, the low-level plans, and computer-executable code that can be executed by the agent in connection with completing the actions, and thus completing these steps, and thus completing the task(s) referenced in the input. For instance, a first machine learning model can be trained to understand screen content and can be used to identify different types of objects rendered by an application, such as text, images, and selectable icons. Accordingly, a description of an action used in connection with performing a task, such as “select the search bar”, can be interpreted appropriately by a second machine learning model based upon an understanding of content rendered by an application. Moreover, a machine learning model can have access to a library of functions (where the functions are optionally ranked), such that an appropriate function can be selected for completion of an action. Example functions may include functions to open an application, functions to select a particular graphical element shown on a display, a function to set forth text, a function to click a mouse, etc.

Using the above referenced collection of machine learning models, the agent can complete relatively complex tasks in response to receipt of relatively complex queries from users. Moreover, to complete a task, the agent need not access a predefined API to interact with an application. Rather, instructions are generated that allow the agent to interact with applications as a human would, thereby allowing for the agent to act as a true assistant to the user.

The above summary presents a simplified summary in order to provide a basic understanding of some aspects of the systems and/or methods discussed herein. This summary is not an extensive overview of the systems and/or methods discussed herein. It is not intended to identify key/critical elements or to delineate the scope of such systems and/or methods. Its sole purpose is to present some concepts in a simplified form as a prelude to the more detailed description that is presented later.

### BRIEF DESCRIPTION OF THE DRAWINGS

FIG. 1 is a schematic that depicts operation of a computer executable agent.

FIG. 2 is a functional block diagram of an architecture of the agent.

FIG. 3 is a functional block diagram of agent memory, where the agent memory is used by the agent in connection with completing tasks.

FIG. 4 is a functional block diagram of a planner module, where the planner module is used by the agent in connection with completing tasks.

FIG. 5 is a functional block diagram of a perception module, where the perception module is used by the agent in connection with completing tasks.

FIG. 6 is a functional block diagram of an action module, where the action module is used by the agent in connection with completing tasks.

FIG. 7 is a schematic that depicts a high-level plan for completing a task, where the high-level plan is output by a generative model.

FIG. 8 is a schematic of a low-level plan output for completing a step of a task, where the low-level plan is output by a generative model.

FIG. 9 is a functional block diagram of a computing system that facilitates performance of a task by an agent.

FIG. 10 depicts a graphical user interface of an application and graphical elements identified in such graphical user interface by a machine learning model.

FIG. 11 is a schematic that depicts performance of a task by an agent.

FIG. 12 is a flow diagram that illustrates a method performed by a computer-executable agent for completing a task.

FIG. 13 depicts a computing system.

### DETAILED DESCRIPTION

Various technologies pertaining to a computer-executable agent that is configured to perform relatively complex tasks are now described with reference to the drawings, wherein like reference numerals are used to refer to like elements throughout. In the following description, for purposes of explanation, numerous specific details are set forth in order to provide a thorough understanding of one or more aspects. It may be evident, however, that such aspect(s) may be practiced without these specific details. In other instances, well-known structures and devices are shown in block diagram form in order to facilitate describing one or more aspects. Further, it is to be understood that functionality that is described as being carried out by certain system components may be performed by multiple components. Similarly, for instance, a component may be configured to perform functionality that is described as being carried out by multiple components.

Moreover, the term “or” is intended to mean an inclusive “or” rather than an exclusive “or.” That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

Further, as used herein, the terms “module” and “system” are intended to encompass computer-readable data storage that is configured with computer-executable instructions that cause certain functionality to be performed when executed by a processor. The computer-executable instructions may include a routine, a function, or the like. It is also to be understood that a module or system may be localized on a single device or distributed across several devices.

Described herein are various technologies pertaining to a computer-executable agent that is configured to assist users of computing devices with completing computer-related tasks. In contrast to tasks that conventional computer-executable agents are configured to perform, the tasks that are performable by the computer-executable agent described herein can be fairly complex. For example, the computer-executable agent can receive the user input “buy me leather shoes that are size 11 and that have at least a four-star rating.” Historically, a computer-executable agent (also referred to as a digital assistant) may be able to provide a selectable link to a webpage where shoes can be purchased; however, the agent is unable to interact with the webpage, leaving the requested task incomplete (and thus requiring the user to, for example, search a website for certain types of shoes, search for the appropriate shoe size, filter the shoes by rating, and so forth). In contrast, the computer-executable agent described herein can cause a webpage of a website to be opened, can initiate a search for size 11 shoes, can filter the search results to exclude shoes that do not have at least a four-star rating, can select the appropriate size from a pull-down menu, and can add the selected shoe to the electronic shopping cart of the webpage. Hence, the agent can complete the task requested by the user.

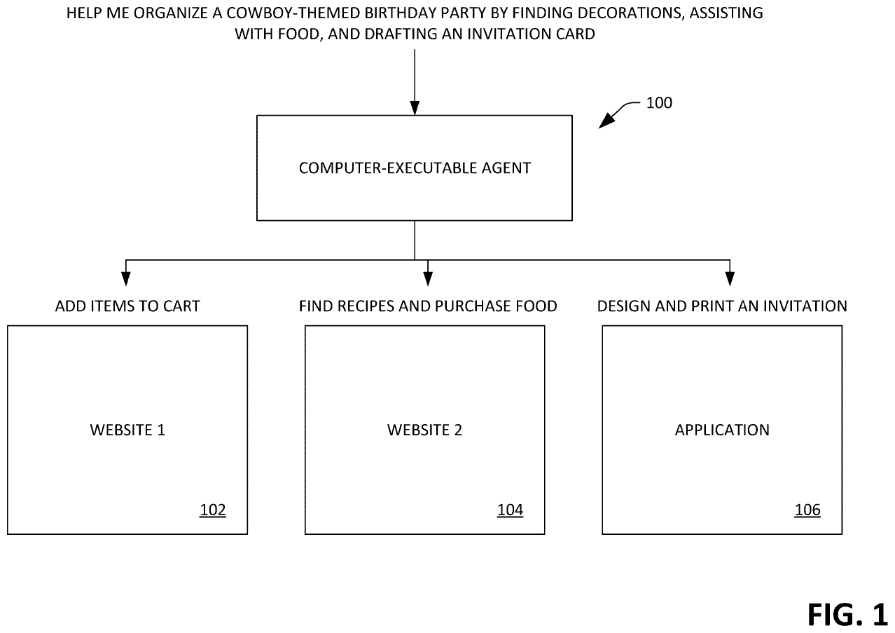

Referring now to FIG. 1, a schematic that depicts operation of a computer-executable agent 100 is presented. The computer-executable agent 100 receives input set forth by a user of a client computing device. In the example shown in FIG. 1, the input is “help me organize a cowboy-themed birthday party by finding decorations, assisting with food, and drafting an invitation card.” Based upon such input, the computer-executable agent 100 can interact with several websites and/or applications (e.g., web applications and/or applications that are installed on the client computing device). For example, the computer-executable agent 100 can cause a web browser to load a webpage of a first website 102, interact with webpages of the first website 102 to locate decorations available for acquisition by way of the first website 102, and add such decorations to an electronic shopping cart of the first website 102. In addition, the computer-executable agent 100 can interact with webpages of a second website 104 to identify recipes for the birthday party referenced in the input and add food items to an electronic cart of the second website 104. Moreover, the computer-executable agent 100 can cause an application 106 (e.g., a web application or an application installed on the client computing device) to be launched, can cause an invitation to be designed by way of the application 106, and can cause the invitation to be printed. Again, this is an improvement over conventional agents, which are limited to performing web searches, performing predefined tasks through use of APIs, and/or constructing textual responses and presenting such responses in a chat interface.

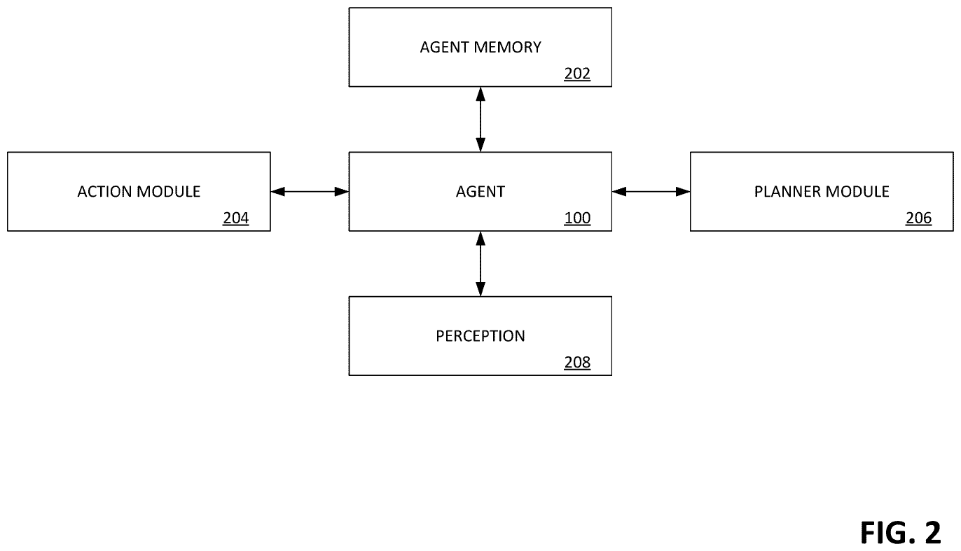

FIG. 2 is a functional block diagram of a high level architecture of the computer-executable agent 100. The computer-executable agent 100 employs various libraries, modules, machine learning models, and historical information in connection with completing tasks requested by the user. For instance, the agent 100 has access to agent memory 202, where the agent memory 202 is configured to retain episodic information over short and long term time periods. An episode is a series of steps (where each step includes at least one action) taken by the agent 100 when completing a task (within an environment). For instance, an episode can represent a single user interaction or a sequence of user interactions with a system or application (e.g., “book a flight to the Seattle airport next week.”). An action is an act taken by the agent 100 within the environment, such as clicking a button, scrolling a webpage, inputting a text string into a text entry field, etc. The agent 100 maintains a state, where the state is a representation of the current condition of the environment (e.g., the computing environment within which the agent is operating). For instance, state maintained by the agent 100 can describe a current status of an application, including user inputs, system settings, and other information that can influence the outcome of an action. For instance, history of displayed graphical user interfaces (GUIs) and history of actions can be a part of the state. The agent 100 can operate in accordance with a policy, where the policy is a set of rules or guidelines that determine actions taken by the agent 100 in a given state. As will be described below, the policy can be a product of output of multiple models (rule-based models or other types of models) in a pipeline.

The agent 100 also has access to an action module 204. The action module 204 includes commands and functions that can be called by the agent 100 in connection with performing an action, such as client computing device functions such as “click” and “scroll”, screen-related functions such as menu functions of available buttons, and so forth. Commands and functions supported by the action module 204 may also include calls to machine learning models.

The agent 100 is further in communication with a planner module 206 that is configured to construct a high-level plan for completing a task and is further configured to construct low-level plans that break down steps into a sequence of actions that can be performed by the agent 100 to complete a step.

The agent 100 is also in communication with a perception module 208. The perception module 208 is configured to generate data that is indicative of the state of the computing device of the user for each step and/or each action. In an example, the perception module 208 can generate images of GUIs, generate information that describes content of the GUIs, and pass such information to the planner module 206.

In operation, the agent 100 receives input from a user, and constructs a prompt based upon such input. The prompt can request that a generative model generate a high-level plan for completing tasks represented in the input. As will be described in greater detail below, the generative model can output an acyclic graph that is representative of the high-level plan. The generative model (or a different generative model) is then provided with a prompt that includes a step represented in the high-level plan, and the planner module 206 outputs a low-level plan for such step, where the low-level plan includes a series of actions that are to be performed by the agent 100 to complete the step. The planner module 206 generates the high-level plan and low-level plans based upon actions accessible to the action module 204, content of the agent memory 202, and output of the perception module 208. The planner module 206 can iteratively generate plans that are performed by the agent 100 until the agent 100 successfully completes the task.

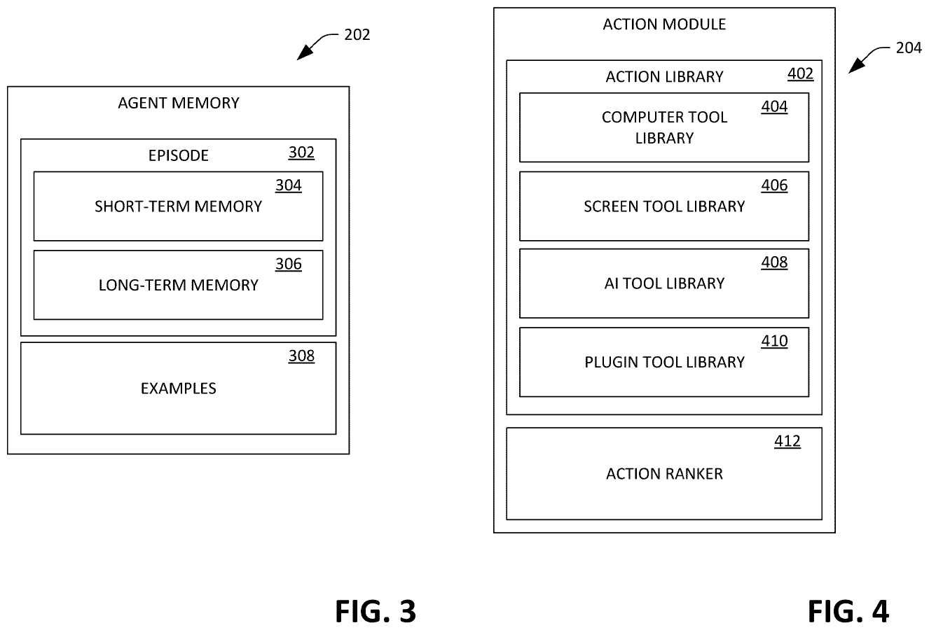

Now referring to FIG. 3, a functional block diagram of the agent memory 202 is presented. The agent memory 202 includes information related to an episode 302. As noted above, the episode 302 represents a series of sequential actions taken by the agent 100 within an environment in connection with completing a task. The agent memory 202 includes short-term memory 304 pertaining to the episode 302 and long-term memory 306 pertaining to the episode 302. The short-term memory 304 can include history of GUIs interacted with by the agent 100 during the episode 302, actions performed by the agent 100 during the episode 302, screen content variables that pertain to the episode 302, and so forth. The long-term memory 306 can include a multi-step plan output by the planner module 206 pertaining to a task, mistakes made by the agent 100 when attempting to complete the task (to avoid repeating of those mistakes if a plan is regenerated), and screen content variables.

The agent memory 202 can also include examples 308, where the examples 308 need not be related to the episode 302. For instance, the examples 308 can include examples that are specific to the user of the computing device, to allow for personalization in outputs generated by the agent 100. The examples 308 can also include general examples that can be employed for in-context use by machine learning models associated with the agent 100.

Referring to FIG. 4, a functional block diagram of the action module 204 is presented. The action module 204 includes an action library 402 that includes tools that are usable by the agent 100 when completing an action. The action library 402 can include a computer tool library 404, which includes functions that are performable by a client computing device. Example functions include click, drag, scroll, type, etc. The action library 402 also includes a screen tool library 406. The screen tool library 406 includes tools that are specific to a current GUI being interacted with by the agent 100. For instance, a GUI can be for a webpage having a document object model (DOM) tree, menus, and/or buttons. The screen tool library 406 can include functions that are configured to facilitate interaction with such elements.

The action library 402 also includes an artificial intelligence (AI) tool library 408. The AI tool library 408 includes AI functions that are local to the computing device. Example functions include semantic file search, summarize, screen question and answering, stable diffusion, and named entity recognition (NER). The action library 402 further includes a plugin tool library 410. The plugin tool library 410 includes functions associated with plugins, such as web search, calculator, calendar, settings, and other plugins.

The action module 204 also optionally includes an action ranker 412. As the number of actions can quickly become intractable when fed as a prompt to a generative model (or provided as input to some other machine learning model), the action ranker 412 can downsize the list of possible functions to the most suitable functions that can be used to achieve the objective of the user at each action, step, or throughout an episode.

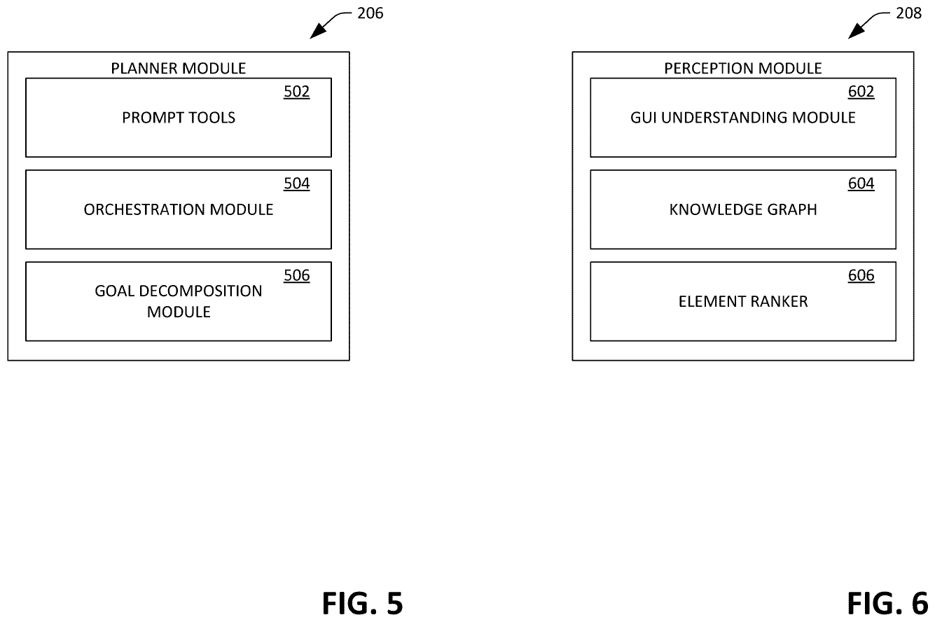

Referring now to FIG. 5, a functional block diagram of the planner module 206 is presented. The planner module 206 includes prompt tools 502 that can be employed in connection with generating prompts for provision to generative models. In addition, the prompt tools 502 can receive the examples 308 in the agent memory 202 in connection with generating prompts. The prompt tools 502 facilitate in-context learning by a generative model as well as construction of chain of thoughts. The prompt tools 502 additionally facilitate multimodal prompting (e.g., where a prompt includes multi-modal content, such as text and image(s)).

The planner module 206 also includes an orchestration module 504 that is configured to coordinate the use of multiple specialized machine learning models. The orchestration module 504 can also facilitate orchestration between cloud and local machine learning models that have various computational requirements to execute. For example, the orchestration module 504 can provide a first prompt to a first machine learning model, receive output from the first machine learning model, construct a second prompt based upon output of the first machine learning model (and the prompt tools 502), and provide the second prompt to a second machine learning model, where the first and second machine learning models execute on different machines.

The planner module 206 also includes a goal decomposition module 506 this is configured to facilitate high-level task planning as well as low level action decomposition and symbolic verification. For instance, the goal decomposition module 506 can be or include a generative model that is prompted to decompose input into a high-level plan and/or prompted to decompose a step of a high-level plan into a sequence of actions.

Turning to FIG. 6, a functional block diagram of the perception module 208 is illustrated. The perception module 208 includes a GUI understanding module 602, where the GUI understanding module 602 can be configured to perform optical character recognition (OCR), NER, extract uniform resource locator (URL) embeddings, etc. The GUI understanding module 602 can also analyze GUIs to understand GUI geometry.

The perception module 208 can also include a knowledge graph 604, where the knowledge graph 604 includes local or network-based content for the user of the computing system and/or an organization to which the user belongs. The perception module 208 can also include an element ranker 606 that can rank relative importance of GUI elements given a current task. For instance, focus of attention of the planner module 206 can be defined by output of the element ranker 606.

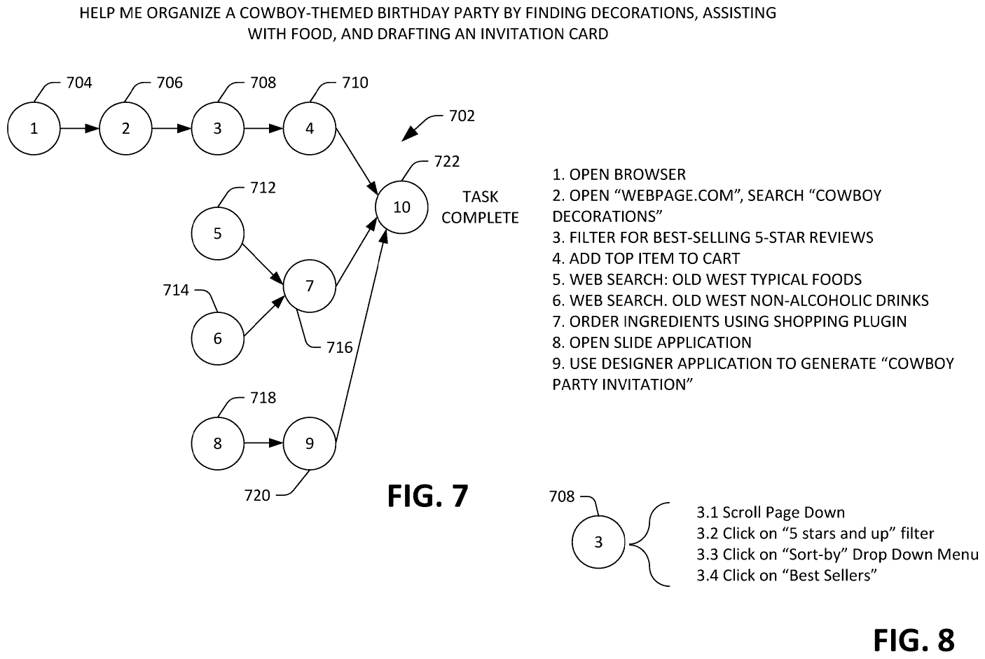

Now referring to FIG. 7, a schematic that depicts an example high-level plan output by the planner module 206 is depicted, where the high-level plan is based upon input (e.g., user input, input generated by a machine learning model, etc.). Continuing with the example set forth above, the input is “help me organize a cowboy-themed birthday party by finding decorations, assisting with food, and drafting an invitation card.” The planner module 206 outputs an acyclic graph 702 that includes nodes 704-722 and directed edges that represent relationships between the nodes 704-722. Each node represents a step that is to be performed by the agent 100 in connection with completing the task represented in the input. For example, the first node 704 can represent the step of opening a web browser. The second node 706 can represent the step of opening a particular webpage and searching for “cowboy decorations” on the webpage. The third node 708 can represent the step of filtering search results for bestselling decorations that have five star reviews. The fourth node 710 can represent the step of adding a top item to the cart to facilitate purchase of such item by the user. The fifth node 712 can represent performance of a web search for “Old West” typical foods. The sixth node 714 can represent the step of performing a web search for “Old West” nonalcoholic drinks. The seventh node 716 can represent a step of ordering ingredients (food items) using a shopping plug in. The eighth node 718 can represent the step of opening a slideshow application. The ninth node 720 can represent the step of using the slide show application to generate a cowboy party invitation. Finally, the 10th node 722 can represent completion of the task.

Pursuant to an example, the planner module 206 includes a generative model that executes on a server computing system that is in network communication with a client computing device operated by the user. Such generative model can be provided with the input as well as a prompt that instructs the generative model to construct the high-level plan in the form of the acyclic graph shown in FIG. 7. The generative model outputs the high-level plan to the agent 100 responsive to generating such high level plan and/or outputs the high-level plan to the planner module 206, which causes the generative model or another machine learning model to generate at least one low-level plan.

FIG. 8 is a schematic that depicts a sequence of actions generated by the planner module 206 with respect to a certain step represented by a node in the acyclic graph 702. In the example shown in FIG. 8, the planner module 206 receives the step represented by the third node 708 and outputs a sequence of actions to be performed by the agent 100 to complete the step (in connection with completing the task). For instance, the planner module 206 outputs four actions: scroll the page down, click on “five stars and up” filter, click on “sort by” drop down menu, and click on “best sellers”. These actions are represented by human readable text in FIG. 8. The planner module 206 can parse such text and transform the actions into computer-executable code that is executable by the agent 100; when the agent 100 executes such code, the sequence of actions is performed. When the agent 100 is unable to complete an action, the planner module 206 can generate an updated sequence of actions for the agent 100 to perform. Specifically, the short-term memory 304 of the agent memory 202 is updated to reflect a failure of the agent 100 and such information is provided to the planner module 206 in connection with generating an updated sequence of actions. Continual failure can result in the planner module 206 outputting an updated or new high-level plan to complete the task.

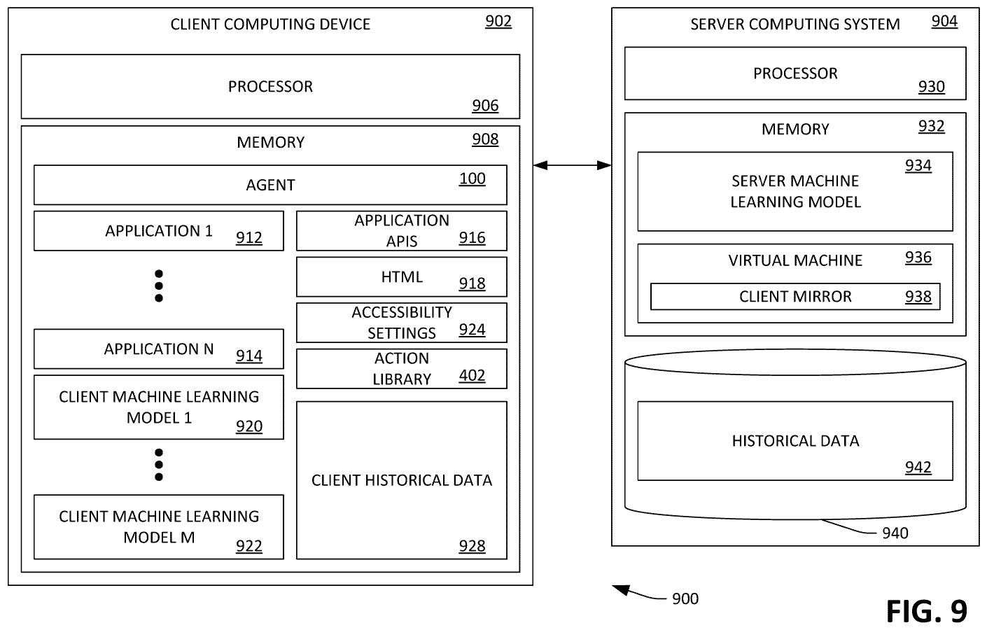

With reference to FIG. 9, a functional block diagram that depicts an example instantiation of the architecture shown in FIG. 2 is presented. A computing system 900 includes a client computing device 902 operated by a user and a server computing system 904 that is in network communication with the client computing device 902. The client computing device 902 may be any suitable type of client computing device, such as a desktop computing device, a laptop computing device, a tablet computing device, a mobile telephone, a wearable computing device, etc. The client computing device 902 includes a processor 906 and memory 908 that includes instructions that are executed by the processor 906 and data that is accessible to the processor 906. For example, the memory 908 includes the agent 100. The memory 908 also includes several applications 912-914 that can be executed by the processor 906. The applications 912-914 can include a web browser, an application for playing videos, an application for playing music, a word processing application, an email application, a spreadsheet application, a slideshow application, or any other suitable application that can be executed by the processor 906 of the client computing device 902.

The memory 908 also optionally includes application APIs 916 by way of which the agent 100 can communicate with at least one application in the applications 912-914. The memory 908 further optionally includes HTML 918 of webpages loaded by a web browser in the applications 912-914. The HTML 918 can include or relate to a DOM tree corresponding to a webpage, such that the perception module 208 can identify locations of selectable graphical items in the webpage.

The memory 910 can further optionally include several machine learning models 920-922 that are executed by the processor 906. Referring to the architecture depicted in FIG. 2, the planner module 206 and/or the perception module 208 can include one or more of the machine learning models 920-922. For instance, the first client machine learning model 920 can obtain an image of a GUI of an application 912 that is launched by the agent 100 in connection with completing a task. The first client machine learning model 920 can identify graphical elements in the GUI, where locations or identities of the graphical elements are provided to the mth client machine learning model 922. In such an example, the first client machine learning model 920 is included in the perception module 208. The mth client machine learning model 922 can output a sequence of actions that are to be performed by the agent 100 based upon the information output by the first client machine learning model 920. In such an example, the mth client machine learning model 922 is included in the planner module 206.

The machine learning models 920-922 can be any suitable type of machine learning model. For instance, the machine learning models 920-922 are or include generative models; in a specific example, at least one of the machine learning models 920-922 is an LLM. The machine learning models 920-922 can have any suitable architecture; hence, at least one of the machine learning models 920-922 can be a transformer-based model, a Generative Adversarial Network-based model, a Variational Autoencoder-based model, and so forth.

The memory 910 further optionally includes accessibility settings 924 for the client computing device 902 and/or the user of the client computing device 902. The accessibility settings 924 can define settings that are accessible to the user of the client computing device 902, and can define features such as those that assist users who may have trouble using their computers normally to obtain more functionality-such as narrating output for those who have vision issues, increasing contrast, etc. At least one of the client machine learning models 920-922 can utilize the accessibility settings 924 when generating output. With respect to the architecture shown in FIG. 2, the accessibility settings 924 can be included in the perception module 208.

Memory 908 further includes the action library 402, which is included in the action module 204. The action library 402 includes the libraries 404-410, as depicted in FIG. 4. While not shown, the memory 908 can further include the action ranker 412.

The memory 910 also includes client historical data 928. The client historical data 928 can pertain to an episode or can extend past the episode. The client historical data 928 includes the short-term memory 304, the long-term memory 306, and/or the examples 308.

The server computing system 904 includes a processor 930 and memory 932, where the memory 932 includes instructions that are executed by the processor 930 and data that is accessible to the processor 930. The memory 932 includes a server machine learning model 934. In an example, the server machine learning model 934 is a generative model that is configured to output a high-level plan (in the form of an acyclic graph) based upon input received from a user at the client computing device 902. Optionally, the processor 930 executes a virtual machine 936 included in the memory 932, where the virtual machine 936 generates a client mirror 938. The client mirror 938 mirrors content of the client computing device 902. The agent 100 can interact with the client mirror 938 so as to prevent a screen of the client computing device 902 from displaying GUIs when the agent 100 is interacting with such screens. Put differently, the agent 100 performs actions to complete tasks on the client mirror 938, and returns results generated by the client mirror 938 without consuming resources of the client computing device 902.

The server computing system 904 also includes a data store 940 that retains historical data 942. The historical data 942 can include at least some of the short-term memory 304, the long-term memory 306, and/or the examples 308.

An example operation of the computing system 900 shown in FIG. 9 is now set forth. The client computing device 902 receives input from the user, where a task that the user is requesting the agent 100 to complete is represented in the input. In an example, the input is “help me organize a cowboy-themed birthday party by finding decorations, assisting with food, and drafting an invitation card.” The agent 100 receives such input and constructs a prompt based upon the input, where the prompt requests that the server machine learning model 934 generate a high-level plan for completing the task. Based upon the prompt, the server machine learning model 934 outputs the aforementioned high-level plan in the form of an acyclic graph. The server computing system 904 transmit the acyclic graph to the client computing device 902, where the acyclic graph is provided to the agent 100.

The agent 100 constructs prompts and provides the prompts to at least some of the client machine learning models 920-922 to generate low-level plans for each step represented by a node in the acyclic graph. For example, the first client machine learning model 920 can be configured to generate low level plans for certain types of steps. Moreover, at least one of the client machine learning models 920-922 can be configured to utilize GUI recognition techniques in connection with grounding the first client machine learning model 920. Referring to the example depicted in FIG. 8, the mth client machine learning model 922 can identify locations of elements in the webpage.com webpage. The mth client machine learning model 922 can provide the locations of the elements and/or identities of the elements as grounding information to the first client machine learning model 920, which generates the low-level plan shown in FIG. 8 based upon the step represented by the third node 708 and the grounding information output by the mth client machine learning model 922. Alternatively or additionally, the first client machine learning model 920 can be grounded with the HTML 918 of the webpage, where the HTML 918 can identify locations of graphical elements in the webpage. The mth client machine learning model 922 can additionally receive a list of functions from the function library 926 as well as the client historical data 928 in connection with generating the low-level plan that is executed by the agent 100. As mentioned previously, the memory 908 may also include a ranker that ranks available functions in the action library 926 based upon at least some of the steps based upon which the low-level plan is to be generated by the first client machine learning model 920.

The first client machine learning model 920 outputs the low-level plan (such as the series of actions shown in FIG. 8), and the agent 100 performs the actions in such plan. If the agent 100 is unable to perform an action, the historical data 928 is updated and the first client machine learning model 920 is re-tasked with constructing the low-level plan. This process can iterate until the agent 100 successfully completes the sequence of actions in the low-level plan. The process described above iterates until the task represented by the acyclic graph output by the server machine learning model 934 is completed. When the agent 100 is not able to complete a sequence of actions in a low-level plan, an updated prompt can be sent to the server machine learning model 934 to regenerate the high-level plan, taking into consideration that the agent 100 is unable to complete the action or sequence of actions.

As described above, the agent 100 can interact with different applications 912-914 when performing actions necessary to complete the task. Such applications may be executing in the client mirror 938, so that computing resources of the client computing device 902 are not utilized when the agent is completing the task.

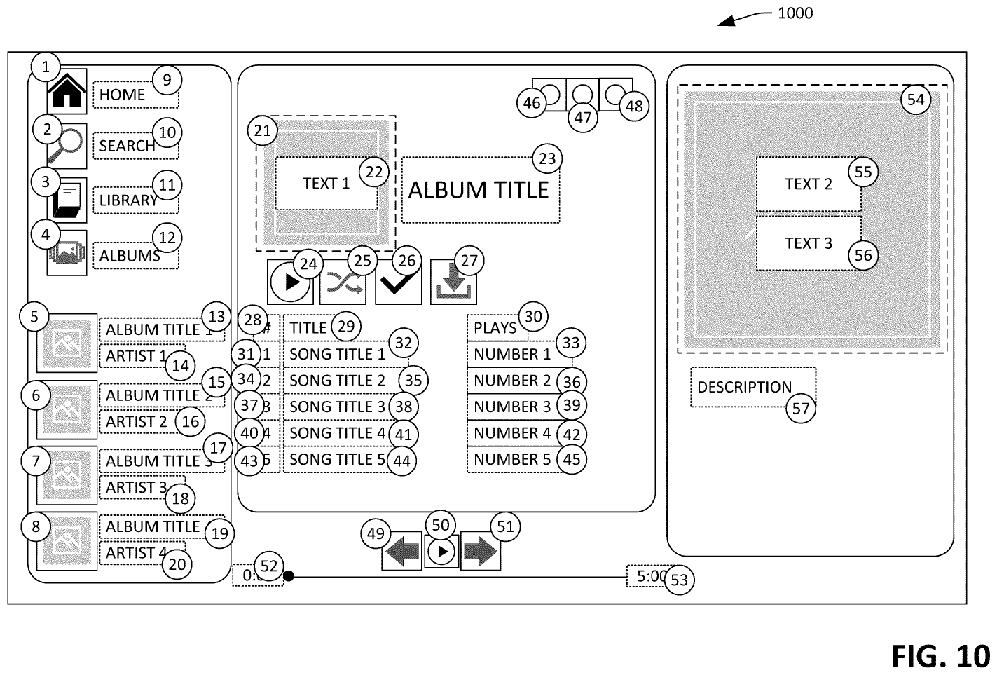

Referring now to FIG. 10, a graphical user interface 1000 of an application in the applications 912-914 is presented. The graphical user interface 1000 may be for an application that is configured to play music. In an example, a user can set forth a request “play me song ‘title’ by ‘artist’”. In connection with performing the task, the agent 100 initiates the application causing a GUI of the application to be rendered by the application. A client machine learning model in the client machine learning models 920-922 receives the GUI and identifies locations in the GUI where text, images, and selectable icons exist. The client machine learning model can then assign a unique identifier, e.g., a number, to each identified element, so that a client machine learning model that is configured to output a low-level plan can include the unique identifier in such plan. Again, information identified based upon the screen recognition technologies can be used to ground a client machine learning model that outputs a low level plan.

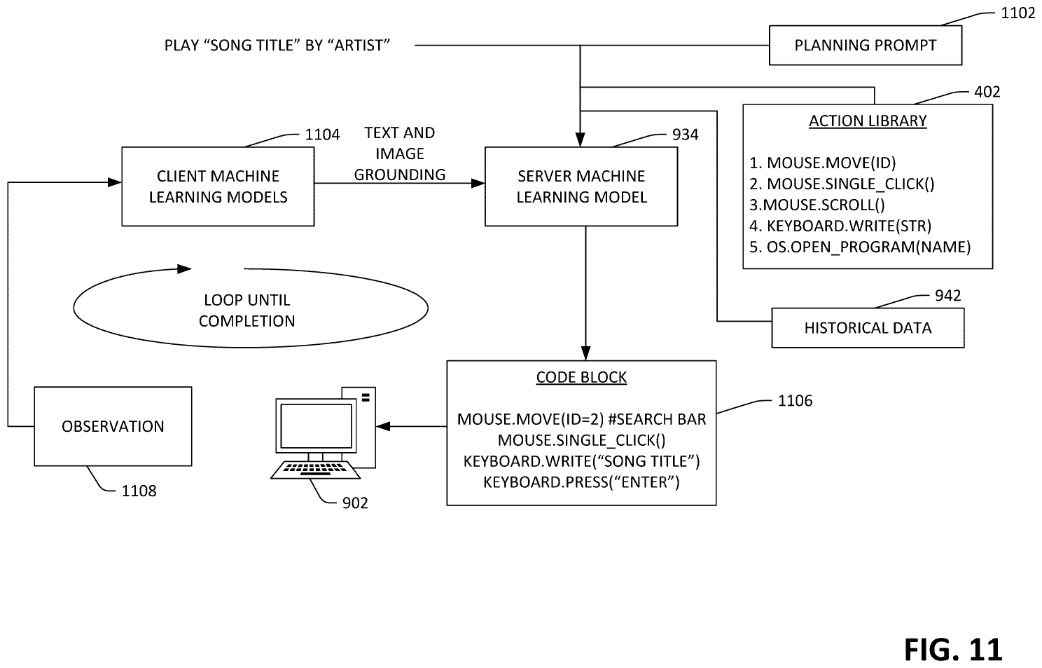

FIG. 11 is a schematic that illustrates operation of portions of the computing system 900 in connection with the agent 100 completing the task of playing the requested song “title” by “artist”. User input “play song ‘title’ by ‘artist’” is received, and the agent 100 generates a planning prompt 1102 based upon the user input. An example of a planning prompt is set forth below. In the example shown in FIG. 11, the server machine learning model 934 generates a high-level plan for completing the task. In addition, in this example, the same server machine learning model 934 can generate at least some low-level plans for steps represented in the acyclic graph generated by the server machine learning model 934. In connection with generating the low-level plans, the server machine learning model 934 can be grounded with functions in the action library 402, the historical data 942, as well as output pertaining to state of the client computing device 902 (e.g., text and images identified in GUIs displayed at the client computing device 902, the accessibility settings 924, etc.). The server machine learning model 934 outputs a code block 1106 that is provided to the client computing device 902, where the agent 100 executes the code block 1106. As is illustrated in the code block 1106, the actions for completing a step include moving a mouse to a search bar (reference numeral 2), having a mouse click on the search bar, entering the text “song title” into the search bar, and then initiating a keyword press of “enter”. The agent 100 then makes an observation 1108 as to whether the agent 100 is able to successfully execute the code block 1106. The observation 1108 can include the client historical data 928, which can then be provided back to the client machine learning models 1104 to further ground the server machine learning model 934 in connection with generating an updated code block. This process loops until the agent 100 successfully executes a code block output by the server machine learning model 924.

While FIG. 11 depicts the server machine learning model 924 generating both the high-level plan and low-level plans, in other examples the server machine learning model 924 only generates the high-level plan. At least one of the client machine learning models 920-922 can generate low-level plans, thereby conserving network bandwidth between the client computing device 902 and the server computing system 904 and conserving processing resources of the server computing system 904, as the server machine learning model 934 may be computationally expensive to execute.

A series of examples is now set forth pertaining to prompts provided to the server machine learning model 934 (or one or more of the client machine learning models 920-922) and outputs generated based upon such prompt. A prompt can explain the context, action space, and expected outputs.

For example, the prompt can define the expected output. An example prompt is as follows:
#Expected output format
Once you analyze the input contents, you are expected to output the following items:
A. Reasoning over the GUI content-answer the following questions:
1. Generally, what is happening in the GUI?
2. What is the active application?
3. What text areas are active, if any?
4. What text is selected?
5. What options could you take next to get closer to your goal?
B. Multi-step planning
1. Describe what happened in the previous GUIs based on the images, actions, and the user's objective.
2. What are the next actions and GUIs you expect between now and the goal?
3. Describe the very next step you should be taking to get closer to the goal?
C. Action to execute in the very next step:
1. Output a python file with this exact structure. Don't forget to include any of the elements shown below, even if they are set to None:
Python
#GUI is current at time step T
#Below is the action executed at time step T
Action_type= . . .
Text_entry= . . .
Touch yx= . . .
Lift_yx= . . .
Execute(action_type, text_entry, touch_yx, lift_yx).

Below is a user prompt message that includes the task instruction and a textual description of each element in the GUI (content of each bounding box) and the previous H actions taken.
1. User's object: turn off JavaScript in the web browser
2, 3, and 4: Please view the image information to view the user's previous 3 (or less) GUI images, the user's current GUI, and the user's current GUI image visually augmented with black bounding boxes and IDs on top of each screen (in this order).
5: a json structure containing details about each screen annotation element follows:
. . . json
{
   “0”: {
      “type”; “ICON_Question”,
      “text”; “ ”,
      “position”: [
         0.07,
         0.908,
         0.104,
         0.939
      ]
   }
   “1”:
      {“type”: “ICON_ARROW_BACKWARD”.
      “text”: “ ”,
      “position”: [
         0.071,
         0.068,
         0.105,
         0.104,
      ]
   }

After processing, the output of the server machine learning model 934 is as follows:
A) Reasoning over the screen content:
1. Generally, what is happening on screen?
   The screen shows the “Site settings” menu within the browser. Various settings are listed, each with an indication of their current status (e.g., “Allowed,”, “Ask first,” “Blocked”).
2. What is the active app?
   The active application is the web browser;
3. What text areas are active, if any?
   There are no active text areas for text entry. The screen contains clickable text items that represent different settings.
4. What text is selected?
   No text is currently selected.
5. What options could you take next to get closer to your goal?
   To get closer to the goal of turning off JavaScript, you would tap on the “JavaScript” setting to access its sub-menu where you can alter its enable status.
B) Multi-step planning:
1. Describe what happened in the previous screenshots based on the images, actions, and the user's objective.
   The user navigated to the browser settings and scrolled down the settings list.
   They then entered the “Site settings” sub-menu, where different site-specific settings such as Cookies, Location, Camera, etc. are displayed.
2. What are the next actions and GUIs you expect between now and the goal?
   The next action is to tap on the “JavaScript” setting.
   Then, on the resulting screen, the user should be able to switch off JavaScript.
3. Describe the very next step you should be taking to get closer to the goal.
   Tap on the “JavaScript” setting to access the options to turn it off.
C) Action to be executed in the very next step:
. . . python
#Screen is current at time step T
#Below is the action executed at time step T
Action_type=4
Text_entry=none
Touch_yx=[0.865, 0.323] #normalized coordinates for the “JavaScript” setting entry.
Lift_yx=[0.865, 0.323]
Execute (action_type, text_entry, touch_yx, lift_yx)
The free-form text output is then parsed into a python script to be executed by the agent 100.

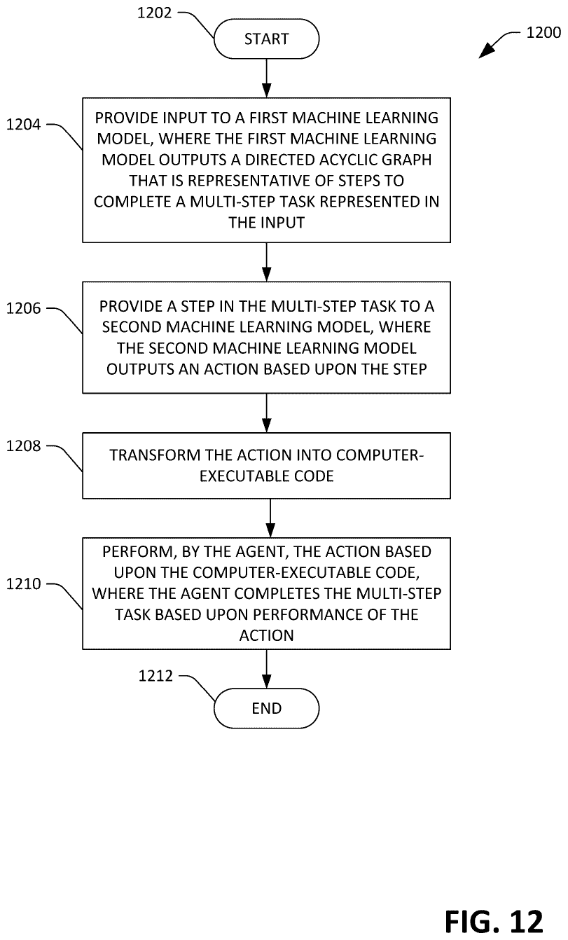

FIG. 12 illustrates an exemplary method relating to performance of a task by a computer-executable agent. While the method is shown and described as being a series of acts that are performed in a sequence, it is to be understood and appreciated that the method is not limited by the order of the sequence. For example, some acts can occur in a different order than what is described herein. In addition, an act can occur concurrently with another act. Further, in some instances, not all acts may be required to implement the method described herein.

Moreover, the acts described herein may be computer-executable instructions that can be implemented by one or more processors and/or stored on a computer-readable medium or media. The computer-executable instructions can include a routine, a sub-routine, programs, a thread of execution, and/or the like. Still further, results of acts of the methodologies can be stored in a computer-readable medium, displayed on a display device, and/or the like.

The method 1200 starts at 1202, and at 1204 input is provided to a first machine learning model, where the first machine learning model outputs a directed acyclic graph that includes nodes and edges based upon the input. The nodes represent steps of a multi-step task to be performed by a computer-executable agent and the edges represent relationships between the steps.

At 1206, a step in the multi-step task is provided to a second machine learning model, where the step is represented by a node in the acyclic graph. The second machine learning model outputs an action based upon the step, where the action is to be performed by the computer-executable agent to complete the step.

At 1208, the action is transformed to computer-executable code that is to be executed by the agent. At 1210, the computer-executable agent performs the action based upon the computer-executable code, where the computer-executable agent completes the multi-step task based upon performance of the action. The method 1200 completes at 1212.

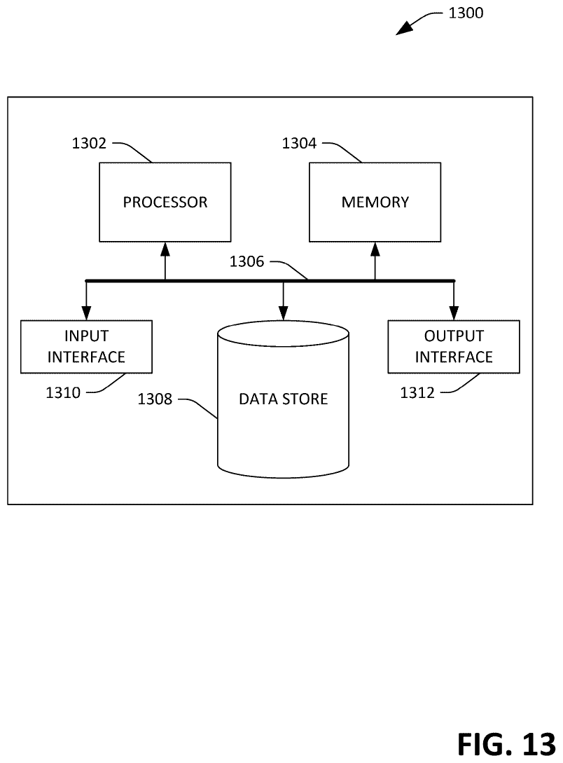

Referring now to FIG. 13, a high-level illustration of an exemplary computing device 1300 that can be used in accordance with the systems and methodologies disclosed herein is illustrated. For instance, the computing device 1300 may be used in a system that executes a computer-executable agent. By way of another example, the computing device 1300 can be used in a system that executes a machine learning model, such as a generative model. The computing device 1300 includes at least one processor 1302 that executes instructions that are stored in a memory 1304. The instructions may be, for instance, instructions for implementing functionality described as being carried out by one or more components discussed above or instructions for implementing one or more of the methods described above. The processor 1302 may access the memory 1304 by way of a system bus 1306. In addition to storing executable instructions, the memory 1304 may also store accessibility settings, user history data, etc.

The computing device 1300 additionally includes a data store 1308 that is accessible by the processor 1302 by way of the system bus 1306. The data store 1308 may include executable instructions, user history data, etc. The computing device 1300 also includes an input interface 1310 that allows external devices to communicate with the computing device 1300. For instance, the input interface 1310 may be used to receive instructions from an external computer device, from a user, etc. The computing device 1300 also includes an output interface 1312 that interfaces the computing device 1300 with one or more external devices. For example, the computing device 1300 may display text, images, etc. by way of the output interface 1312.

It is contemplated that the external devices that communicate with the computing device 1300 via the input interface 1310 and the output interface 1312 can be included in an environment that provides substantially any type of user interface with which a user can interact. Examples of user interface types include graphical user interfaces, natural user interfaces, and so forth. For instance, a graphical user interface may accept input from a user employing input device(s) such as a keyboard, mouse, remote control, or the like and provide output on an output device such as a display. Further, a natural user interface may enable a user to interact with the computing device 1300 in a manner free from constraints imposed by input device such as keyboards, mice, remote controls, and the like. Rather, a natural user interface can rely on speech recognition, touch and stylus recognition, gesture recognition both on screen and adjacent to the screen, air gestures, head and eye tracking, voice and speech, vision, touch, gestures, machine intelligence, and so forth.

Additionally, while illustrated as a single system, it is to be understood that the computing device 1300 may be a distributed system. Thus, for instance, several devices may be in communication by way of a network connection and may collectively perform tasks described as being performed by the computing device 1300.

Various functions described herein can be implemented in hardware, software, or any combination thereof. If implemented in software, the functions can be stored on or transmitted over as one or more instructions or code on a computer-readable medium. Computer-readable media includes computer-readable storage media. A computer-readable storage media can be any available storage media that can be accessed by a computer. By way of example, and not limitation, such computer-readable storage media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray disc (BD), where disks usually reproduce data magnetically and discs usually reproduce data optically with lasers. Further, a propagated signal is not included within the scope of computer-readable storage media. Computer-readable media also includes communication media including any medium that facilitates transfer of a computer program from one place to another. A connection, for instance, can be a communication medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio and microwave are included in the definition of communication medium. Combinations of the above should also be included within the scope of computer-readable media.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Various technologies have been described herein in accordance with at least the following examples.
(A1) In an aspect, a method performed by a processor of a computing system includes providing input to a first machine learning model, where the first machine learning model outputs a directed acyclic graph that includes nodes and edges based upon the input. The nodes represent steps of a multi-step task to be performed by a computer-executable agent and the edges represent relationships between the steps. The method also includes providing a step in the multi-step task to a second machine learning model, where the step is represented by a node in the acyclic graph. The second machine learning model outputs an action based upon the step, where the action is to be performed by the computer-executable agent to complete the step. The method additionally includes transforming the action into computer-executable code that is to be executed by the computer-executable agent. The method further includes performing, by the computer-executable agent, the action based upon the computer-executable code, where the computer-executable agent completes the multi-step task based upon performance of the action.
(A2) In some embodiments of the method of (A1), the computing system is a client computing device. Further, providing the input to the first machine learning model includes transmitting the input to a server computing system that is in network communication with the client computing device.
(A3) In some embodiments of the method of (A2), the second machine learning model executes on the client computing device.
(A4) In some embodiments of the method of at least one of (A1)-(A3), providing the input to the first machine learning model comprises constructing a prompt, where the prompt includes an instruction for the first machine learning model to output the directed acyclic graph.
(A5) In some embodiments of the method of (A4), the first machine learning model is a generative model.
(A6) In some embodiments of the method of at least one of (A1)-(A5), providing the step in the multi-step task to the second machine learning model comprises constructing a prompt, where the prompt instructs the second machine learning model to output a sequence of actions that complete the step.
(A7) In some embodiments of the method of (A6), the prompt includes identities of functions that are available to the computer-executable agent to complete at least one action in the sequence of actions.
(A8) In some embodiments of the method of (A7), the method also includes obtaining an image of a graphical user interface (GUI) of an application being executed by the computing system. The method further includes providing the image to a third machine learning model, where the third machine learning model is configured to identify elements in the GUI that are interactive, where the prompt includes the elements in the GUI that are identified as being interactive by the third machine learning model.
(A9) In some embodiments of the method of (A8), the prompt additionally includes identities of previous actions performed by the computer-executable agent in connection with completing the multi-step task.
(A10) In some embodiments of the method of at least one of (A1)-(A9), the computer-executable agent fails to complete the multi-step task subsequent to performing the action. The method also includes providing a prompt to the first machine learning model, where the first machine learning model outputs a second directed acyclic graph based upon the prompt, where the second directed acyclic graph includes second nodes and second edges, where the second nodes represent second steps of the multi-step task to be performed by the computer-executable agent, where the second steps are non-identical to the steps.
(B1) In another aspect, a method performed by a processor of a computing system includes obtaining input, where the input is representative of a multi-step task that is to be performed by a computer-executable agent. The method also includes providing the input to a first machine learning model, where the first machine learning model outputs a high-level plan based upon the input, where the high-level plan includes steps that are to be performed by the computer-executable agent to complete the task. The method additionally includes providing a step in the steps to a second machine learning model, where the second machine learning model outputs a low-level plan based upon the step, where the low-level plan includes a sequence of actions that are to be performed by the computer-executable agent to complete the step. The method further includes performing, by the computer-executable agent, the sequence of actions output by the second machine learning model, where the computer-executable agent completes the multi-step task based upon the performing of the sequence of actions.
(B2) In some embodiments of the method of (B1), the computing system is a client computing device, and further where providing the input to the first machine learning model comprises transmitting the input to a server computing system that is in network communication with the client computing device.
(B3) In some embodiments of the method of (B2), the second machine learning model executes on the client computing device.
(B4) In some embodiments of the method of at least one of (B1)-(B3), providing the input to the first machine learning model comprises constructing a prompt, where the prompt includes an instruction for the first machine learning model to output the high-level plan.
(B5) In some embodiments of the method of (B4), the first machine learning model is a generative model.
(B6) In some embodiments of the method of at least one of (B1)-(B5), providing the step in the multi-step task to the second machine learning model includes constructing a prompt, where the prompt instructs the second machine learning model to output the sequence of actions.
(B7) In some embodiments of the method of (B6), the prompt includes identities of functions that are available to the computer-executable agent to complete at least one action in the sequence of actions.
(B8) In some embodiments of the method of (B7), the method also includes obtaining an image of a GUI of an application being executed by the computing system. The method also includes providing the image to a third machine learning model, where the third machine learning model is configured to identify elements in the GUI that are interactive, where the prompt includes the elements in the GUI that are identified as being interactive by the third machine learning model.
(B9) In some embodiments of the method of (B8), the prompt additionally includes identities of previous actions performed by the computer-executable agent in connection with completing the multi-step task.
(C1) In another aspect, a computing system includes a processor and memory, where the memory stores instructions that, when executed by the processor, cause the processor to perform at least one of the methods disclosed herein (e.g., any of (A1)-(A10) or (B1)-(B9)).
(D1) In yet another aspect, a computer-readable storage medium includes instructions that, when executed by a processor, cause the processor to perform at least one of the methods disclosed herein (e.g., any of (A1)-(A10) or (B1)-(B9)).

What has been described above includes examples of one or more embodiments. It is, of course, not possible to describe every conceivable modification and alteration of the above devices or methodologies for purposes of describing the aforementioned aspects, but one of ordinary skill in the art can recognize that many further modifications and permutations of various aspects are possible. Accordingly, the described aspects are intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A computing system comprising:
a processor; and
memory storing instructions that, when executed by the processor, cause the processor to perform acts comprising:
providing input to a first machine learning model, where the first machine learning model outputs a directed acyclic graph that includes nodes and edges based upon the input, where the nodes represent steps of a multi-step task to be performed by a computer-executable agent and the edges represent relationships between the steps;
providing a step in the multi-step task to a second machine learning model, where the step is represented by a node in the acyclic graph, where the second machine learning model outputs an action based upon the step, where the action is to be performed by the computer-executable agent to complete the step;
transforming the action into computer-executable code that is to be executed by the computer-executable agent; and
performing, by the computer-executable agent, the action based upon the computer-executable code, where the computer-executable agent completes the multi-step task based upon performance of the action.

2. The computing system of claim 1, where the computing system is a client computing device, and further where providing the input to the first machine learning model comprises transmitting the input to a server computing system that is in network communication with the client computing device.

3. The computing system of claim 2, where the second machine learning model executes on the client computing device.

4. The computing system of claim 1, where providing the input to the first machine learning model comprises constructing a prompt, where the prompt includes an instruction for the first machine learning model to output the directed acyclic graph.

5. The computing system of claim 4, where the first machine learning model is a generative model.

6. The computing system of claim 1, where providing the step in the multi-step task to the second machine learning model comprises constructing a prompt, where the prompt instructs the second machine learning model to output a sequence of actions that complete the step.

7. The computing system of claim 6, where the prompt includes identities of functions that are available to the computer-executable agent to complete at least one action in the sequence of actions.

8. The computing system of claim 7, the acts further comprising:
obtaining an image of a graphical user interface (GUI) of an application being executed by the computing system; and
providing the image to a third machine learning model, where the third machine learning model is configured to identify elements in the GUI that are interactive, where the prompt includes the elements in the GUI that are identified as being interactive by the third machine learning model.

9. The computing system of claim 8, where the prompt additionally includes identities of previous actions performed by the computer-executable agent in connection with completing the multi-step task.

10. The computing system of claim 1, where the computer-executable agent fails to complete the multi-step task subsequent to performing the action, the acts further comprising:
providing a prompt to the first machine learning model, where the first machine learning model outputs a second directed acyclic graph based upon the prompt, where the second directed acyclic graph includes second nodes and second edges, where the second nodes represent second steps of the multi-step task to be performed by the computer-executable agent, where the second steps are non-identical to the steps.

11. A method performed by a processor of a computing system, the method comprising:
obtaining input, where the input is representative of a multi-step task that is to be performed by a computer-executable agent;
providing the input to a first machine learning model, where the first machine learning model outputs a high-level plan based upon the input, where the high-level plan includes steps that are to be performed by the computer-executable agent to complete the task;
providing a step in the steps to a second machine learning model, where the second machine learning model outputs a low-level plan based upon the step, where the low-level plan includes a sequence of actions that are to be performed by the computer-executable agent to complete the step; and
performing, by the computer-executable agent, the sequence of actions output by the second machine learning model, where the computer-executable agent completes the multi-step task based upon the performing of the sequence of actions.

12. The method of claim 11, where the computing system is a client computing device, and further where providing the input to the first machine learning model comprises transmitting the input to a server computing system that is in network communication with the client computing device.

13. The method of claim 12, where the second machine learning model executes on the client computing device.

14. The method of claim 11, where providing the input to the first machine learning model comprises constructing a prompt, where the prompt includes an instruction for the first machine learning model to output the high-level plan.

15. The method of claim 14, where the first machine learning model is a generative model.

16. The method of claim 11, where providing the step in the multi-step task to the second machine learning model comprises constructing a prompt, where the prompt instructs the second machine learning model to output the sequence of actions.

17. The method of claim 16, where the prompt includes identities of functions that are available to the computer-executable agent to complete at least one action in the sequence of actions.

18. The method of claim 17, further comprising:
obtaining an image of a graphical user interface (GUI) of an application being executed by the computing system; and
providing the image to a third machine learning model, where the third machine learning model is configured to identify elements in the GUI that are interactive, where the prompt includes the elements in the GUI that are identified as being interactive by the third machine learning model.

19. The method of claim 18, where the prompt additionally includes identities of previous actions performed by the computer-executable agent in connection with completing the multi-step task.

20. A computer-readable storage medium comprising instructions that, when executed by a processor, cause the processor to perform acts comprising:
providing input to a first machine learning model, where the first machine learning model outputs a directed acyclic graph that includes nodes and edges based upon the input, where the nodes represent steps of a multi-step task to be performed by a computer-executable agent and the edges represent relationships between the steps;
providing a step in the multi-step task to a second machine learning model, where the step is represented by a node in the acyclic graph, where the second machine learning model outputs an action based upon the step, where the action is to be performed by the computer-executable agent to complete the step;
transforming the action into computer-executable code that is to be executed by the computer-executable agent; and
performing, by the computer-executable agent, the action based upon the computer-executable code, where the computer-executable agent completes the multi-step task based upon performance of the action.
